(19) United States
(12) Patent Application Publication
(10) Pub. No.: US 2023/0116341 A1
(43) Pub. Date: Apr. 13, 2023

(54) METHODS AND APPARATUSES FOR HAND GESTURE-BASED CONTROL OF SELECTION FOCUS

(71) Applicants: Futian ZHANG, Waterloo (CA); Edward LANK, Cambridge (CA); Sachi MIZOBUCHI, Toronto (CA); Gaganpreet SINGH, Markham (CA); Wei ZHOU, Richmond Hill (CA); Wei LI, Markham (CA)

(72) Inventors: Futian ZHANG, Waterloo (CA); Edward LANK, Cambridge (CA); Sachi MIZOBUCHI, Toronto (CA); Gaganpreet SINGH, Markham (CA); Wei ZHOU, Richmond Hill (CA); Wei LI, Markham (CA)

(21) Appl. No.: 17/958,177

(22) Filed: Sep. 30, 2022

Related U.S. Application Data
(60) Provisional application No. 63/250,605, filed on Sep. 30, 2021.

(51) Int. Cl. G06F 3/01; G06F 3/0485; G06V 40/20

(52) U.S. Cl. CPC G06F 3/017; G06F 3/0485; G06V 40/28

(57) ABSTRACT

Methods and apparatuses for controlling a selection focus of a user interface using gestures, in particular mid-air hand gestures, are described. A hand is detected within a defined activation region in a first frame of video data. The detected hand is tracked to determine a tracked location of the detected hand in at least a second frame of video data. A control signal is outputted to control the selection focus to focus on a target in the user interface, where movement of the selection focus is controlled based on a displacement between the tracked location and a reference location in the activation region.

### CROSS-REFERENCE TO RELATED APPLICATIONS

The present disclosure claims priority from U.S. Provisional Pat. Application No. 63/250,605, entitled “METHODS AND APPARATUSES FOR HAND GESTURE-BASED CONTROL OF SELECTION FOCUS”, filed Sep. 30, 2021, the entirety of which is hereby incorporated by reference.

### FIELD

The present disclosure relates to detection and recognition of a hand gesture for remote control of a selection focus in a user interface.

### BACKGROUND

Machine vision-based detection (generally referred to in the art as computer vision) of hand gestures (e.g., detected in a sequence of frames of a digital video captured by a camera) has been of interest for enabling a way for a user to remotely interact (i.e., without physical contact) with an electronic device. The electronic device may be, for example, a smartphone, a smart device (e.g., smart television, smart appliance, etc.), a tablet, a laptop or an in-vehicle system (e.g., an in-vehicle infotainment system, or an interactive dashboard display). Some existing technologies use an approach where specific gestures are mapped to specific control inputs.

A challenge with existing gesture-based technologies is that they typically assume that the user is in an uncluttered, open environment (e.g., a large indoor space), and that the user knows and can use different, precise hand gestures to interact with the device (e.g., user is able to perform complex hand gestures). Further, many existing gesture recognition technologies assume that a user’s eyes are focused on a display of the device being controlled, such that the user has continuous visual feedback to help adjust the gesture input to achieve the desired interaction. Such conditions may not be met in all applications where remote control of a device is desirable. For example, such conditions typically cannot be met when a user is attempting to interact with an in-vehicle system in a moving vehicle, where a user (e.g., a driver) should have their eyes focused on a different task (e.g., focused on the road). In another example, an inexperienced user in a crowded environment (e.g., a user interacting with a public kiosk in a mall) may find it challenging to interact with a user interface using specific defined gestures.

It would be useful to provide a robust solution to enable a user to remotely interact with and navigate a user interface using hand gestures, in a variety of applications.

### SUMMARY

In various examples, the present disclosure describes methods and apparatuses enabling detection and recognition of a mid-air hand gesture for controlling a selection focus in a user interface. The present disclosure describes example methods and apparatuses for tracking a user’s gesture input, which may help to reduce instances of false positive errors (e.g., errors in which a selection focus is moved contrary to the user’s intention).

In particular, the present disclosure describes different example approaches for mapping detected gesture inputs to control a selection focus to focus on a desired target in the user interface. In some examples, the present disclosure provides the technical advantage that gesture inputs are detected and recognized to enable selection of a target in a user interface, using an approach that is more robust and useable in less than ideal conditions. Examples of the present disclosure may be less sensitive to small aberrations in gesture input, which may enable the use of gesture inputs in a wider variety of applications, including for user interaction with a user interface of an in-vehicle system, among other applications.

In some examples, the present disclosure describes a method including: detecting a hand within a defined activation region in a first frame of video data, a reference location being determined within the defined activation region; tracking the detected hand to determine a tracked location of the detected hand in at least a second frame of video data; and outputting a control signal to control a selection focus to focus on a target in a user interface, movement of the selection focus being controlled based on a displacement between the tracked location and the reference location.

In an example of the above example aspect of the method, the method may include: determining whether the displacement between the tracked location and the reference location satisfies a defined distance threshold; where the control signal may be outputted in response to determining that the defined distance threshold is satisfied.

In an example of any of the above example aspects of the method, the method may include: recognizing a gesture of the detected hand in the first frame as an initiation gesture; and defining a first location of the detected hand in the first frame as the reference location.

In an example of any of the above example aspects of the method, the method may include: detecting, in the first frame or a third frame of video data that is prior to the first frame, a reference object; and defining a size and position of the activation region relative to the detected reference object.

In an example of the above example aspect of the method, the detected reference object may be one of: a face; a steering wheel; a piece of furniture; an armrest; a podium; a window; a door; or a defined location on a surface.

In an example of any of the above example aspects of the method, the method may include: recognizing, in the second or a fourth frame of video data that is subsequent to the second frame, a gesture of the detected hand as a confirmation gesture; and outputting a control signal to confirm selection of the target that the selection focus is focused on in the user interface.

In an example of any of the above example aspects of the method, outputting the control signal may include: mapping the displacement between the tracked location and the reference location to a mapped position in the user interface; and outputting the control signal to control the selection focus to focus on the target that is positioned in the user interface at the mapped position.

In an example of the above example aspect of the method, the method may include: determining that the mapped position is an edge region of a displayed area of the user interface; and outputting a control signal to scroll the displayed area.

In an example of the above example aspect of the method, the control signal to scroll the displayed area may be outputted in response to determining at least one of: a tracked speed of the detected hand is below a defined speed threshold; or the mapped position of the selection focus remains in the edge region for at least a defined time threshold.

In an example of any of the above example aspects of the method, the method may include: determining a speed to scroll the displayed area, based on the displacement between the tracked location and the reference location, where the control signal may be outputted to scroll the displayed area at the determined speed

In an example of any of the above example aspects of the method, outputting the control signal may include: computing a velocity vector for moving the selection focus, the velocity vector being computed based on the displacement between the tracked location and the reference location; and outputting the control signal to control the selection focus to focus on the target in the user interface based on the computed velocity vector.

In an example of the above example aspect of the method, the method may include: determining that the computed velocity vector would move the selection focus to an edge region of a displayed area of the user interface; and outputting a control signal to scroll the displayed area.

In an example of the above example aspect of the method, the control signal to scroll the displayed area may be outputted in response to determining at least one of: a magnitude of the velocity is below a defined speed threshold; or the selection focus remains in the edge region for at least a defined time threshold.

In an example of any of the above example aspects of the method, the method may include: determining a speed to scroll the displayed area, based on the computed velocity vector, where the control signal may be outputted to scroll the displayed area at the determined speed.

In an example of any of the above example aspects of the method, outputting the control signal may include: determining a direction to move the selection focus based on a direction of the displacement between the tracked location and the reference location; and outputting the control signal to control the selection focus to focus on a next target in the user interface in the determined direction.

In an example of the above example aspect of the method, determining the direction to move the selection focus may be in response to recognizing a defined gesture of the detected hand in the first frame.

In an example of the above example aspect of the method, the method may include: determining that the displacement between the tracked location and the reference location satisfies a defined paging threshold that is larger than the defined distance threshold; and outputting a control signal to scroll a displayed area of the user interface in the determined direction.

In an example of the above example aspect of the method, the method may include: determining that the next target in the user interface is outside of a displayed area of the user interface; and outputting a control signal to scroll the displayed area in the determined direction, such that the next target is in view.

In some example aspects, the present disclosure describes an apparatus including: a processing unit coupled to a memory storing machine-executable instructions thereon, wherein the instructions, when executed by the processing unit, cause the apparatus to perform any of the above example aspects of the method.

In an example of the above example aspect of the apparatus, the apparatus may be one of: a smart appliance; a smartphone; a tablet; an in-vehicle system; an internet of things device; an electronic kiosk; an augmented reality device; or a virtual reality device.

In some example aspects, the present disclosure describes a computer-readable medium having machine-executable instructions stored thereon, the instructions, when executed by a processing unit of an apparatus, causing the apparatus to perform any of the above example aspects of the method.

In some example aspects, the present disclosure describes a computer program comprising instructions which, when the program is executed by an apparatus, cause the apparatus to carry out any of the above example aspects of the method.

### BRIEF DESCRIPTION OF THE DRAWINGS

Reference will now be made, by way of example, to the accompanying drawings which show example embodiments of the present application, and in which:

FIGS. 1A and 1B are block diagrams illustrating a user interacting with example electronic devices, in accordance with examples of the present disclosure;

FIG. 2 is a block diagram illustrating some components of an example electronic device, in accordance with examples of the present disclosure;

FIGS. 3A-3E illustrate some example hand gestures that may be detected and recognized as gesture input, in accordance with examples of the present disclosure;

FIG. 4 is a block diagram illustrating some details of an example selection focus controller that may be implemented in an example electronic device, in accordance with examples of the present disclosure;

FIG. 5 illustrates an example user interface that a user may interact with by controlling a selection focus, in accordance with examples of the present disclosure;

FIG. 6 is a flowchart illustrating an example method for controlling a selection focus in a user interface, in accordance with examples of the present disclosure;

FIG. 7 is a flowchart illustrating an example position-based control technique for mapping gesture input to control of a selection focus, in accordance with examples of the present disclosure;

FIG. 8 is a flowchart illustrating an example position-scroll-based control technique for mapping gesture input to control of a selection focus, in accordance with examples of the present disclosure;

FIG. 9 is a flowchart illustrating an example rate-based control technique for mapping gesture input to control of a selection focus, in accordance with examples of the present disclosure;

FIG. 10 is a flowchart illustrating an example discrete control technique for mapping gesture input to control of a selection focus, in accordance with examples of the present disclosure;

FIGS. 11 and 12 illustrate examples of how a user may perform gesture inputs to control a selection focus using the rate-based control technique, in accordance with examples of the present disclosure; and

FIGS. 13 and 14 illustrate examples of visual feedback that may be provided to help a user to perform gesture inputs to control a selection focus, in accordance with examples of the present disclosure.

Similar reference numerals may have been used in different figures to denote similar components.

### DETAILED DESCRIPTION

In various examples, the present disclosure describes methods and apparatuses enabling gesture-based control of a user interface provided on an electronic device. Mid-air hand gestures (i.e., gestures that are performed without being in physical contact with the device) may be used to control movement of a selection focus in the user interface, in order to focus on and select a target in the user interface. In the present disclosure, an electronic device may be any device that supports user control of a selection focus in a user interface, including a television (e.g., smart television), a mobile communication device (e.g., smartphone), a tablet device, a desktop device, a vehicle-based device (e.g., an infotainment system or an interactive dashboard device), a wearable device (e.g., smartglasses, smartwatch or head mounted display (HMD)) or a smart speaker, among other possibilities. The user interface may be a display-based user interface (e.g., a graphic user interface (GUI) displayed on a display screen, or a virtual GUI in an augmented reality (AR) display) or may not require a display (e.g., a user interface may be provided by physical buttons, and a selection focus may be indicated by lighting up different buttons). Examples of the present disclosure may also be implemented for AR, virtual reality (VR), or video game applications, among other possibilities.

For simplicity, the present disclosure describes examples in the context of an electronic device having a display output (e.g., a smart television, smartphone, interaction dashboard display or tablet), and describes gesture-based control for interacting with a GUI. However, it should be understood that the present application is not limited to such embodiments, and may be used for gesture-based control of a variety of electronic devices in a variety of applications.

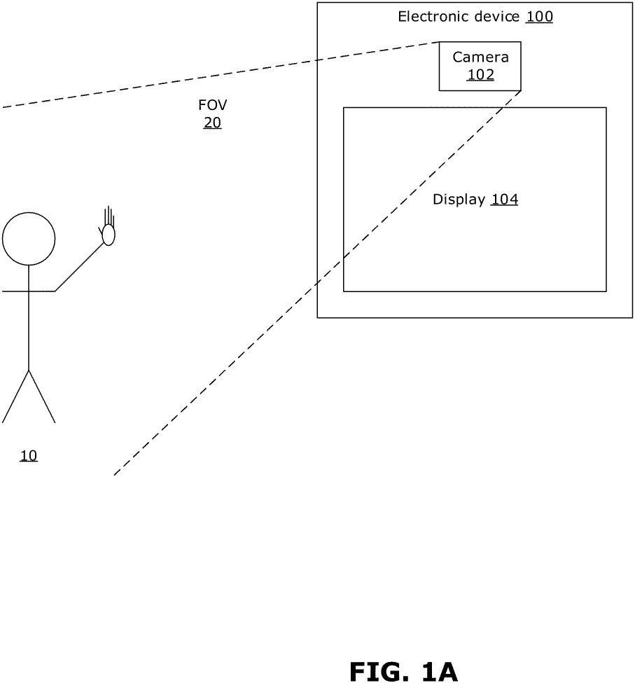

FIG. 1A shows an example of a user 10 interacting with an electronic device 100. In this simplified diagram, the electronic device 100 includes a camera 102 that captures a sequence of frames (e.g., digital images) of video data in a field-of-view (FOV) 20. The FOV 20 may include at least a portion of the user 10, in particular a hand of the user 10 and optionally a head or other reference body part, as discussed further below. The electronic device 100 may, instead of or in addition to the camera 102, have another sensor capable of sensing gesture input from the user 10, for example any image capturing device/sensor (e.g., an infrared image sensor) that captures a sequence of frames (e.g., infrared images) of video data. The electronic device 100 also includes a display 104 providing an output, such as a GUI.

FIG. 1B shows another example of a user 10 interacting with an electronic device 100. In this simplified diagram, the camera 102 is a peripheral device that is external to and in communication with the electronic device 100. The camera 102 may capture frames of video data, which may be processed (by a software system of the camera 102 or a software system of the electronic device 100) to detect and recognize a gesture input performed by the user 10 within the FOV 20. In particular, in the example of FIG. 1B, the display 104 of the electronic device 100 may not be within the line-of-sight or may not be the primary visual focus of the user 10. For example, the electronic device 100 may be an interactive dashboard display of a vehicle and the user 10 (e.g., a driver of the vehicle) may be focused on a view of the road instead of the display 104.

Some existing techniques for supporting user interaction with an in-vehicle system (e.g., in-vehicle infotainment system, interactive dashboard display, etc.) are now discussed.

Conventionally, a display for an in-vehicle system is located on the dashboard near the steering wheel and controlled by buttons (e.g., physical buttons or soft buttons) adjacent to the display and/or by touch screen. However, depending on the size and position of the display, and the physical capabilities of the user, not all buttons and/or portions of the touch screen may not be comfortably reachable by the user. Some in-vehicle systems can be controlled via input mechanisms (e.g., buttons, touchpad, etc.) located on the steering wheel. This may enable the driver to remotely control the in-vehicle system, but not other passengers. Some in-vehicle systems provide additional controls to the passenger via additional hardware (e.g., buttons, touchpad, etc.) located at passenger-accessible locations (e.g., between driver and passenger seats, on the back of the driver seat, etc.). However, the additional hardware increases manufacturing complexity and costs. Further, the problem of reachability remains, particularly for smaller-sized passengers or passengers with disabilities. Voice-based interaction with in-vehicle systems may not be suitable in noisy situations (e.g., when a radio is playing, or when other conversation is taking place), and voice-based control of a selection focus is not intuitive to most users.

It should be understood that the challenges and drawbacks of existing user interaction technologies as described above are not limited to in-vehicle systems. For example, it may be desirable to provide solutions that support a user to remotely interact with a user interface of a public kiosk. Many existing kiosks support touch-based user interaction. However, it may not be hygienic for a user to touch a public surface. Further, it is inconvenient for a user to have to come into close proximity with the kiosk display in order to interact with the user interface. User interactions with smart appliances (e.g., smart television) may also benefit from examples of the present disclosure, because it is not always convenient for a user to come into physical contact (e.g., to provide touch input, or to interact with physical buttons) to interact with a smart appliance. As well, in the case of devices with a large display area (e.g., smart television), it may be more comfortable for a user to view a user interface from a distance.

The present disclosure describes methods and apparatuses that enable a user to remotely interact with a user interface, including to remotely control a selection focus of a user interface provided by an electronic device, using mid-air hand gestures (i.e., without physical contact with the electronic device).

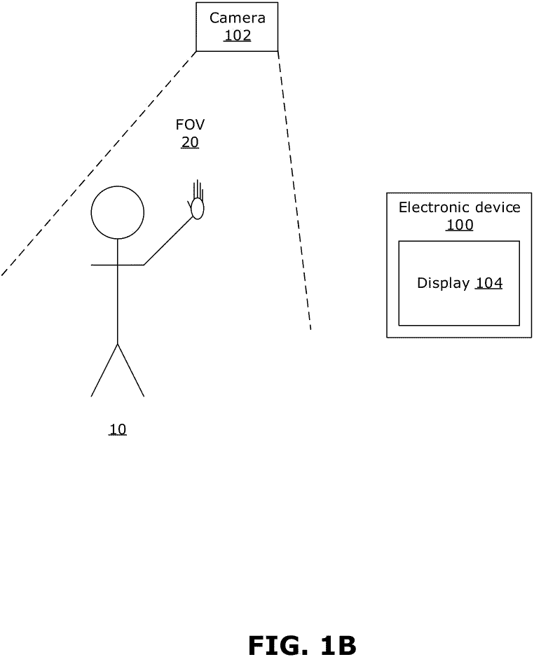

FIG. 2 is a block diagram showing some components of an example electronic device 100 (which may also be referred to generally as an apparatus), which may be used to implement embodiments of the present disclosure. Although an example embodiment of the electronic device 100 is shown and discussed below, other embodiments may be used to implement examples disclosed herein, which may include components different from those shown. Although FIG. 2 shows a single instance of each component, there may be multiple instances of each component shown.

The electronic device 100 includes one or more processing units 202, such as a processor, a microprocessor, an application-specific integrated circuit (ASIC), a field-programmable gate array (FPGA), a dedicated logic circuitry, a dedicated artificial intelligence processor unit, or combinations thereof. The electronic device 100 also includes one or more input/output (I/O) interfaces 204, which interfaces with input devices such as the camera 102 (which may be part of the electronic device 100 as shown in FIG. 1A, or may be separate from the electronic device 100 as shown in FIG. 1B) and output devices such as the display 104. The electronic device 100 may include other input devices (e.g., buttons, microphone, touchscreen, keyboard, etc.) and other output devices (e.g., speaker, vibration unit, etc.). The camera 102 (or other input device) may have capabilities for capturing a sequence of frames of video data. The captured frames may be provided by the I/O interface(s) 204 to memory(ies) 208 for storage (e.g. buffering therein), and provided to the processing unit(s) 202 to be processed in real-time or near real-time (e.g., within 10 ms).

The electronic device 100 may include one or more optional network interfaces 206 for wired or wireless communication with a network (e.g., an intranet, the Internet, a P2P network, a WAN and/or a LAN) or other node. The network interface(s) 206 may include wired links (e.g., Ethernet cable) and/or wireless links (e.g., one or more antennas) for intra-network and/or inter-network communications.

The electronic device 100 includes one or more memories 208, which may include a volatile or non-volatile memory (e.g., a flash memory, a random access memory (RAM), and/or a read-only memory (ROM)). The non-transitory memory(ies) 208 may store instructions for execution by the processing unit(s) 202, such as to carry out examples described in the present disclosure. For example, the memory(ies) 208 may include instructions, executable by the processing unit(s) 202, to implement a selection focus controller 300, discussed further below. The memory(ies) 208 may include other software instructions, such as for implementing an operating system and other applications/functions 210. For example, the memory(ies) 208 may include software instructions 210 for generating and displaying a user interface, which may be controlled using control signals from the selection focus controller 300.

In some examples, the electronic device 100 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the electronic device 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the electronic device 100 may communicate with each other via a bus, for example.

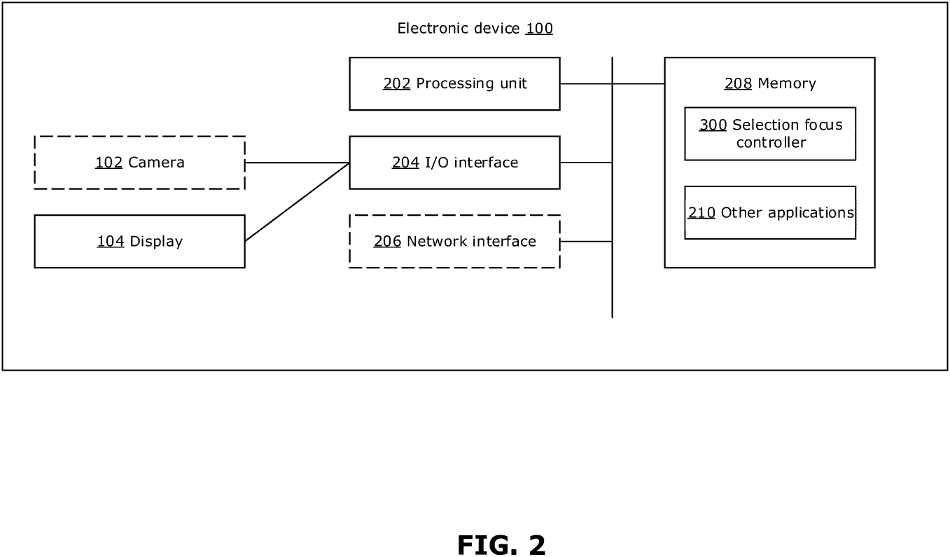

To help in understanding the present disclosure, a discussion of gestures is first provided. In the present disclosure, a hand gesture is generally defined as a distinct hand shape that may be recognized by the electronic device 100 (e.g., using a gesture classification algorithm, such as a machine learning-based classifier) as a particular command input. A hand gesture may have different shapes and movement. Some example hand gestures that may be recognized by the electronic device 100 are shown in FIGS. 3A-3E. A hand gesture such as those shown in FIGS. 3A-3E, that is present in a frame (e.g. a current frame of video data) captured by the camera 102 is referred to as a gesture input.

FIG. 3A illustrates an “open hand” gesture 30; FIG. 3B illustrates a “fist” (or “closed hand”) gesture 32; FIG. 3C illustrates a “pinch open” (or “L-shape”) gesture 34; FIG. 3D illustrates a “pinch closed” gesture 36; and FIG. 3E illustrates a “touch” (or “select”) gesture 38. Other gestures may be recognized by the electronic device 100.

Different gestures may be interpreted as different control inputs. For example, the open hand gesture 30 may be interpreted as a start interaction gesture (e.g., to initiate user interactions with a user interface); the fist gesture 32 may be interpreted as an end interaction gesture (e.g., to end user interactions with the user interface); the pinch open gesture 34 may be interpreted as an initiate selection focus gesture (e.g., to begin controlling a selection focus of the user interface); the pinch closed gesture 36 may be interpreted as a move selection focus gesture (e.g., to control movement of the selection focus in the user interface); and the touch gesture 38 may be interpreted as a confirmation gesture (e.g., to confirm selection of a target in the user interface that the selection focus is currently focused on). Other interpretations of the gestures may be used by the electronic device 100.

The electronic device 100 may use any suitable gesture classification algorithm to classify and interpret different hand gestures, such as those described in PCT application no. PCT/CN2020/080416, entitled “METHODS AND SYSTEMS FOR HAND GESTURE-BASED CONTROL OF A DEVICE”, filed Mar. 20, 2020 and incorporated herein by reference in its entirety.

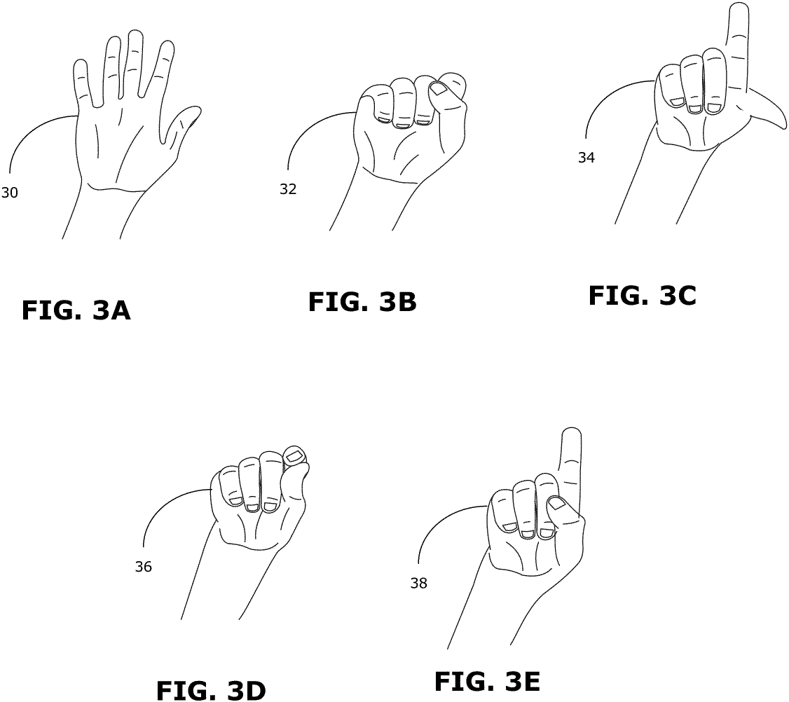

FIG. 4 is a block diagram illustrating an example embodiment of the selection focus controller 300.

The selection focus controller 300 receives as input a captured frame of video data (or a sequence of frames of video data) and outputs a user interface (UI) control signal. The selection focus controller 300 may output UI control signals that control a selection focus of the UI as well as aspects of the UI. The UI control signal may, for example, control a selection focus of a UI, to move the selection focus among different targets (e.g., selectable options) of the UI. The UI control signal may, in the case where the UI has a scrollable displayed area (e.g., the area of the UI exceeds the area that can be displayed at any one time), cause the displayed area to be scrolled. The UI control signal may also confirm selection of target that the selection focus is currently focused on.

In this example, the selection focus controller 300 includes a plurality of subsystems: a reference object detector 302, a hand detector 304, a hand tracker 306, a gesture classifier 308 and a gesture-to-control subsystem 310. Although the selection focus controller 300 is illustrated as having certain subsystems, it should be understood that this is not intended to be limiting. For example, the selection focus controller 300 may be implemented using greater or fewer numbers of subsystems, or may not require any subsystems (e.g., functions described as being performed by certain subsystems may be performed by the overall selection focus controller 300). Further, functions described herein as being performed by a particular subsystem may instead be performed by another subsystem. Generally, the functions of the selection focus controller 300, as described herein, may be implemented in various suitable ways within the scope of the present disclosure. Example operation of the selection focus controller 300 will now be described with reference to the subsystems shown in FIG. 4.

The reference object detector 302 performs detection on the captured frame of video data, to detect the presence of a defined reference object (e.g., a reference body part of the user such as a face, shoulder or hip; or a reference object in the environment such as a window, a door, an armrest, a piece of furniture such as a sofa, a speaker’s podium, steering wheel, etc.; or a defined location on a surface such as a marked location on the ground) and the location of the reference object. The reference object detector 302 may use any suitable detection technique (depending on the defined reference object). For example, if the reference object has been defined to be a face of the user, any suitable face detection algorithm (e.g., a trained neural network that is configured and trained to perform a face detection task) may be used to detect a face in the captured frame and to generate a bounding box for the detected face. For example, a trained neural network such as YoloV3 may be used to detect a face in the captured frame and to generate a bounding box for the detected face (e.g., as described in Redmon et al. “Yolov3: An incremental improvement,” arXiv preprint arXiv:1804.02767, 2018) based on a residual neural network (ResNet) architecture such as ResNet34 (e.g., as described in He, Kaiming, et al. “Deep residual learning for image recognition.” Proceedings of the IEEE conference on computer vision and pattern recognition. 2016). Another example of a suitable trained neural network configured for face detection may be a trained single shot detector (SSD) such as multibox SSD (e.g., as described in Liu et al. “Ssd: Single shot multibox detector.” European conference on computer vision. Springer, Cham, 2016.) based on a convolutional neural network (CNN) architecture such as MobileNetV2 (e.g., as described in Sandler et al. “Mobilenetv2: Inverted residuals and linear bottlenecks.” Proceedings of the IEEE Conference on Computer Vision and Pattern Recognition. 2018.). The location of the detected reference object (e.g., as defined by the center of the bounding box of the detected reference object) may be used to define the size and/or position of a defined activation region (discussed further below). In some examples, if the defined activation region is fixed (e.g., a fixed region of the captured frame) or is not used (e.g., hand detection is performed using the entire area of the captured frame), the reference object detector 302 may be omitted.

The hand detector 304 performs hand detection on the captured frame of video data, to detect the presence of a detected hand. The hand detection may be performed only within the defined activation region (discussed further below) of the captured frame, to reduce computation time and reduce the use of computer resources. The hand detector 304 may use any suitable hand detection technique, including machine learning-based algorithms (e.g., a trained neural network that is configured and trained to perform a hand detection task). For example, any of the neural networks described above with respect to the face detection may be configured and trained to perform hand detection. The hand detector 304 may output a bounding box for the detected hand.

The hand tracker 306 performs operations to track the location of the detected hand (e.g., track the location of the bounding box of the detected hand) in the captured frame after a hand has been detected by the hand detector 304. In some examples, the hand tracker 306 may track the detected hand only within the defined activation region. In other examples, the hand tracker 306 may track the detected anywhere within the captured frame. Because hand tracking may be less computationally complex than hand detection, the computational burden of tracking a detected hand anywhere within a captured frame (i.e., not limited to the defined activation region) may be relatively low. The hand tracker 306 may use any hand tracking technique, such as the Lucas-Kanade optical flow technique (as described in Lucas et al. “An iterative image registration technique with an application to stereo vision.” Proceedings of Imaging Understanding Workshop, 1981). In some examples, the hand detector 304 and the hand tracker 306 may be implemented together as a combined hand detection and tracking subsystem. Regardless of whether the hand detector 304 and the hand tracker 306 are implemented as separate subsystems or as a single subsystem, the tracked bounding box is outputted to the gesture classifier 308.

The bounding box for the detected hand is used by the gesture classifier 308 to perform classification of the shape of the detected hand in order to recognize a gesture. The gesture classifier 308 may use any suitable classification technique to classify the shape of the detected hand (within the bounding box) as a particular gesture (e.g., any one of the gestures illustrated in FIGS. 3A-3E). For example, the gesture classifier 308 may include a neural network (e.g., a CNN) that has been trained to recognize (i.e., estimate or predict) a gesture within the bounding box according to a predefined set of gesture classes. The gesture class predicted by the gesture classifier 308 may be outputted (e.g., as a label) to the gesture-to-control subsystem 310.

The gesture-to-control subsystem 310 performs operations to map the recognized gesture (e.g., as indicated by the gesture class label) and the tracked location of the detected hand (e.g., as indicated by the tracked bounding box) to the UI control signal. Various techniques may be used to perform this mapping, which will be discussed further below.

To assist in further understanding the present disclosure, an example UI is now discussed. It should be understood that the example UI is not intended to be limiting, and the present disclosure may encompass other types of UI for other applications.

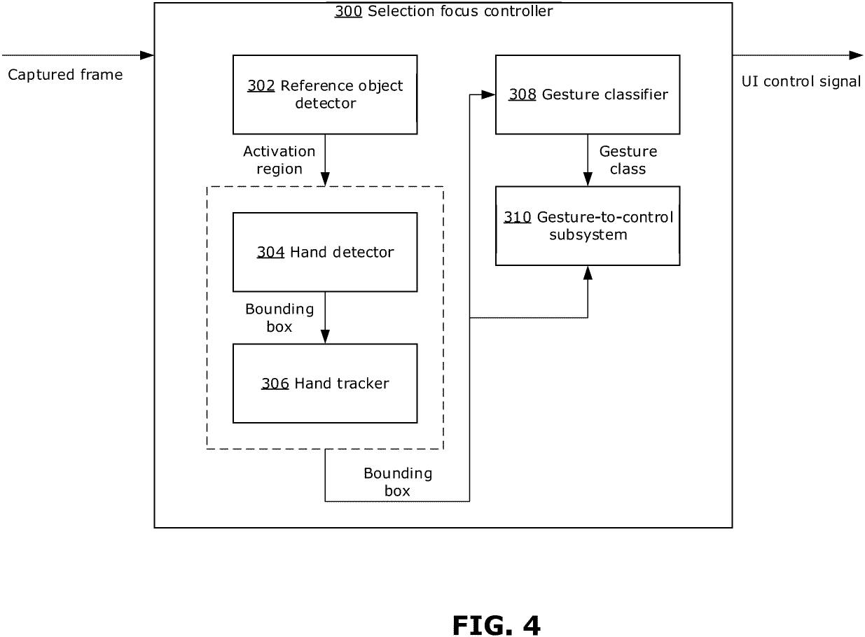

FIG. 5 illustrates a simplified example of a UI 400, which may be controlled using UI control signals outputted by the selection focus controller 300. The UI 400 may be presented by an in-vehicle infotainment system, for example.

In this example, the UI 400 includes a plurality of selection targets 402, such as icons representing (in clockwise order starting from top left) selectable options for activating an email application, a telephone application, a music application, a temperature control application, a map application, and returning to a previous menu. In particular, each selection target 402 may be selected by moving a selection focus 404 to focus on the desired selection target 402 and confirming selection of the target 402 (using UI control signals).

The selection focus 404 is moved by discretely moving between targets 402 (e.g., the selection focus 404 “hops” from one target 402 to the next) rather than moving in a continuous path (e.g., in the manner of a cursor). For example, if the selection focus 404 is moved from a first target 402 to a second target 402, this may be observed by the user as the selection focus 404 first being focused on the first target 402 (e.g., by highlight the first target 402), then the selection focus 404 “hops” to focus on the second target 402. Using a discretely-moving selection focus 404 rather than a cursor-based approach (e.g., similar to a cursor controlled by mouse input) to focus on a target 402 may enable a user to interact with the UI 400 in less than ideal conditions. For example, if a user’s eyes are focused on another task (e.g., focused on the road), discrete movement of the selection focus 404 may be controlled with less or no visual feedback to the user (e.g., audio or haptic feedback may be provided to the user when the selection focus 404 has moved to a next target 402). In another example, if a user is unable to precisely control their hand (e.g., the user has limited motor control, or the user’s hand is frequently jostled by crowds or by being in a moving vehicle), discrete movement of the selection focus 404 is less prone to false positive errors (e.g., less prone to be moved in a direction not intended by the user) compared to a cursor-based approach.

In this example, the total area of the UI 400 (i.e., the area necessary to encompass all six targets 402) is larger than the area that is displayable (e.g., the electronic device 100 has a small display 104). Accordingly, a displayed area 410 of the UI 400 is smaller than the total area of the UI 400, and not all targets 402 are displayed at the same time. In order to view targets 402 that are not currently displayed, the displayed area 410 of the UI 400 may be scrolled. In the example of FIG. 5, the displayed area 410 may be scrolled to the right to display the targets 402 for activating the music application and the temperature control application (and thus resulting in the targets 402 for the email application and for returning to a previous menu to be moved out of view). As will be discussed further below, scrolling of the displayed area 410 may, in some examples, be controlled by moving the selection focus 404 to an edge region 406 of the displayed area 410. The edge region 406 may be defined as a border or margin (e.g., having a defined width) along the edge of the displayed area 410. The edge region 406 may also be defined to extend infinitely outside of the displayed area 410 (i.e., regions outside of the displayed area 410 are also considered to be edge regions 406). There may be multiple edge regions 406, for example a left edge region and right edge region, and possibility also a top edge region and bottom edge region, which may be used to scroll the displayed area 410 in corresponding directions.

Examples of the operation of the selection focus controller 300 for controlling the selection focus 404 of the UI 400 are now discussed.

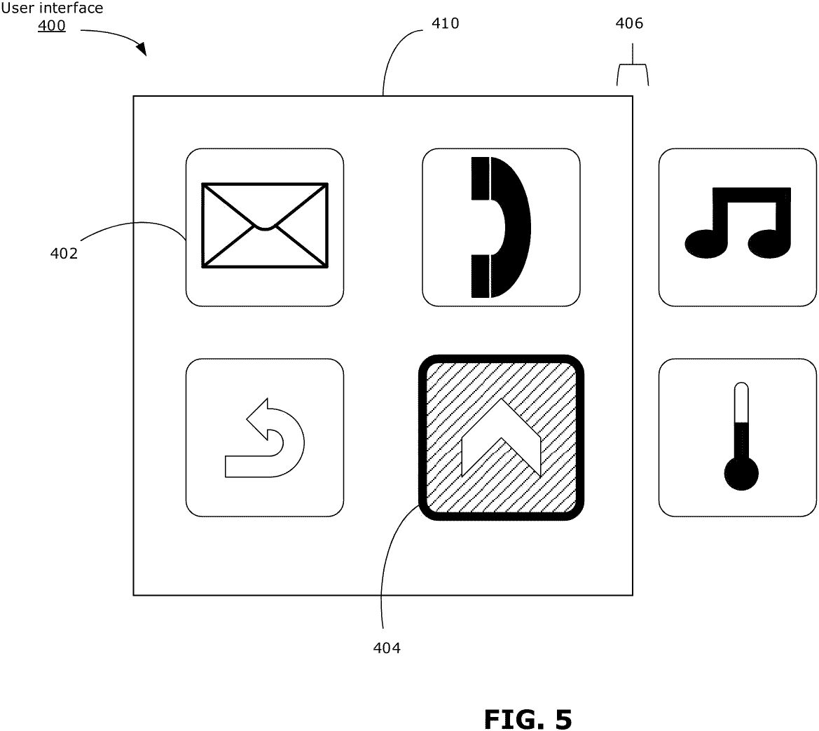

FIG. 6 is a flowchart illustrating an example method 600 for controlling a selection focus in a UI. For example, the method 600 may be implemented by the electronic device 100 using the selection focus controller 300 (e.g., by the processing unit 202 executing instructions stored in the memory 208, to implement the selection focus controller 300).

Optionally, at 602, an activation region may be defined relative to a detected reference object. The activation region is a region defined in the captured frame of video data in which hand detection is performed. In some examples, it may be assumed that the activation region of the frame where a user’s hand should be positioned to interact with the UI is fixed, and step 602 may be omitted. For example, if the user is expected to be at a known position relative to the camera capturing the video data (e.g., the user is expected to be approximately seated in a vehicle in a known location and position relative to a camera mounted inside the vehicle), then the user’s hand may also be expected to be positioned in a known region of the captured frame whenever the user is interacting with the UI. In another example, hand detection may not be limited to the activation region (e.g., hand detection may be performed over the entire area of the captured frame), and step 602 may be omitted.

If step 602 is performed, steps 604 and 606 may be used to perform step 602.

At 604, a defined reference object is detected in the captured frame, for example using the reference object detector 302. As described above, the reference object may be a face or other body part of the user, or a relatively static environmental object such as a window, door, steering wheel, armrest, piece of furniture, speaker’s podium, defined location on the ground, etc. The location and size of the detected reference object (e.g., as indicated by the bounding box of the detected reference object) may be used to define the activation region.

At 606, the size and position of the activation region in the captured frame are defined, relative to the detected reference object. For example, the position of the activation region may be defined to be next to (e.g., abut), encompass, overlap with, or in proximity to the bounding box of the detected reference object (e.g., based on where the user’s hand is expected to be found relative to the detected reference object). The size of the activation region may be defined as a function of the size of the detected reference object (e.g., the size of the bounding box of the detected reference object). This may enable the size of the activation region to be defined in a way that accounts for the distance between the camera and the user. For example, if the user is farther away from the camera, the size of a detected face of the user is smaller and hence the activation region may also be smaller (because typical movement of the user’s hand is expected to be within a smaller region of the captured frame). Conversely, if the user is closer to the camera, the size of the detected face is larger and hence the activation region may also be larger (because typical movement of the user’s hand is expected to be within a larger region of the captured frame). In an example, if the reference object is defined as the user’s face, the size of the activation region may be defined as a function of the width of the detected face, such as the activation region being a region of the captured frame that is five face-widths wide by three face-widths high. In another example, the size of the activation region may be a function of the size of the reference object, but not necessarily directly proportional to the size of the reference object. For example, the activation region may have a first width and height when the size of the reference object is within a first range, and the activation region may have a second (larger) width and height when the size of the reference object is within a second (larger) range.

At 608, a hand is detected within the activation region in the captured frame, for example using the hand detector 304. The activation region may be defined using step 602 as described above, or may be a fixed defined region of the captured frame. In some examples, the activation region may be defined as the entire area of the captured frame. A reference location is also determined within the activation region. The reference location may be a predefined and fixed location within the activation region (e.g., the center of the activation region). Alternatively, the reference location may be defined as the location of the detected hand (e.g., the center of the bounding box of the detected hand) when the hand is first detected in the activation region or when an initiation gesture is first recognized (as discussed further below).

At 610, hand tracking is performed on the detected hand (e.g., using the hand tracker 306 and the gesture classifier 308) in at least one next captured frame (e.g., at least one frame subsequent to the frame in which the hand was detected at step 608). Handing tracking may be performed to determine a tracked location of the detected hand in one or more frames subsequent to the frame in which hand detection was performed. By tracking movement of the detected hand over a sequence of frames, a tracked speed of the detected may also be determined. Gesture classification may also be performed on the detected hand to recognize the type of gesture (e.g., gesture class, which may be interpreted as a particular type of control gesture) performed by the detected hand.

At 612, a control signal is outputted to control the selection focus in the user interface, based on displacement of the tracked location relative to the reference location (e.g., using the gesture-to-control subsystem 310). Various techniques for determining the appropriate control and outputting the control signal, using at least the tracked location (and optionally also the tracked speed), may be used. Some example methods for implementing step 612 will be discussed further below.

Steps 610–612 may be performed repeatedly, over a sequence of captured frames of video data, to control the selection focus in the user interface. The control of the selection focus may end (and the method 600 may end) if the detected hand is no longer detected anywhere in the captured frame, if the detected hand is no longer detected within the activation region, or if an end user interaction gesture is recognized, for example.

If a confirmation gesture is detected in any captured frame (e.g., gesture classification at step 610 recognizes a gesture that is interpreted as confirmation of a selection), the method 600 may proceed to optional step 614.

At 614, a control signal is outputted to confirm the selection of a target that the selection focus is currently focused on in the user interface, in response to detection and recognition of the confirmation gesture. The electronic device 100 may then perform operations in accordance with the confirmed selection (e.g., execute an application corresponding to the selected target) and the method 600 may end.

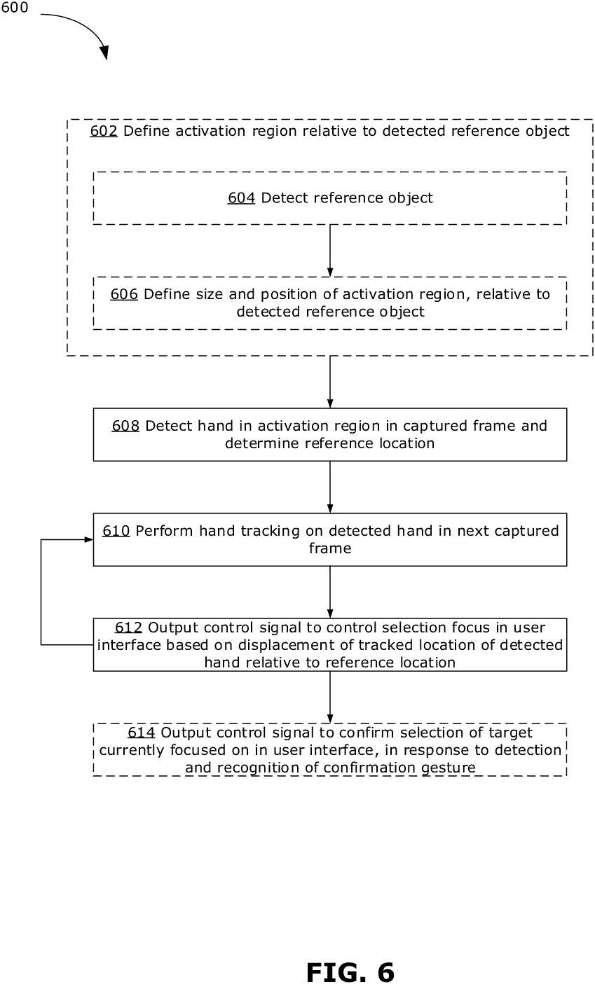

FIG. 7 is a flowchart illustrating an example method 700 for mapping the tracked location and gesture of the detected hand to a control signal. The method 700 may be referred to as “position-based” control, for example.

The method 700 may enable the selection focus to be controlled in a way that maps the position of the user’s hand to a position of the selection focus in the user interface, while maintaining the discrete (or hop-based) motion of the selection focus.

Optionally, at 702, an initiation gesture is recognized to initiate control of the selection focus. The initiation gesture may be recognized for the detected hand within the defined activation region. For example, the initiation gesture may be a pinch closed gesture or some other predefined gesture performed by the detected hand within the defined activation region.

Optionally, at 704, the reference location may be defined based on the location of the detected hand when the initiation gesture is recognized. For example, the reference location may be defined as the location of the center of the bounding box of the detected hand when the initiation gesture is recognized. In another example, if gesture recognition involves identifying keypoints of the hand (e.g., the gesture classifier 308 performs keypoint detection), the reference location may be defined as the location of the tip of the index finger when the initiation gesture is recognized.

At 706, the detected hand is tracked in a next captured frame of video data. A tracked location of the detected hand is determined for at least one next captured frame of video data. In some examples, by tracking the detected hand over a sequence of frames of video data, a tracked speed of the detected may be determined.

At 708, it is determined whether the displacement between the tracked location and the reference location satisfies a defined distance threshold (e.g., meets or exceeds the distance threshold). By ensuring that the tracked location has moved at least the defined distance threshold away from the reference location, false positive errors (e.g., due to minor jostling of the user’s hand) may be avoided. The distance threshold may be a defined based on the size of a reference object (e.g., detected at step 604). For example, if the reference object is a detected face of the user, the distance threshold may be defined to be one-sixth of the face width. Defining the distance threshold based on the size of the reference object may enable the distance threshold to be defined in a way that accounts for the distance between the user and the camera.

If the displacement of between the tracked location and the reference location satisfies the defined distance threshold, the method 700 proceeds to step 710. Otherwise, the method 700 returns to step 706 to continue tracking the detected hand.

At 710, a control signal is outputted to control the selection focus to focus on a target that is positioned in the UI at a position corresponding to the displacement between the tracked location and the reference location. That is, the selected target is at a position in the UI that corresponds to the tracked location of the detected hand (relative to the reference location). To maintain the discrete movement of the selection focus, the UI may be divided into sub-regions that each map to a respective target within the respective sub-region. Then any position in the UI within a given sub-region is mapped to control the selection focus to focus on the target within the given sub-region.

For example, the tracked location of the detected hand may be mapped to a position in the UI using a mapping that maps the area of the activation region to the area of the displayed area of the UI. Then, movement of the detected hand within the activation region can be mapped to corresponding movement of the selection focus to a target of the UI. In a simplified example, if the displayed area of the UI shows four targets, each in a respective quadrant of the displayed area, then movement of the detected to a given quadrant of the activation region may be mapped to movement of the selection focus to the target in the corresponding given quadrant of the displayed area. Mapping the area of the displayed area to the area of the activation region in this way may help to ensure that the user only needs to move their hand within the activation region in order to access all portions of the displayed area. In some examples, the user may be provided with feedback (e.g., a dot or other indicator, in addition to the selection focus) to indicate the position in the displayed area of the UI to which the tracked location of the detected hand has been mapped. Such feedback may help the user to control the selection focus in the desired manner.

The position-based control technique, as described above with reference to FIG. 7, may provide a relatively simple way for a user to control the selection focus of the UI.

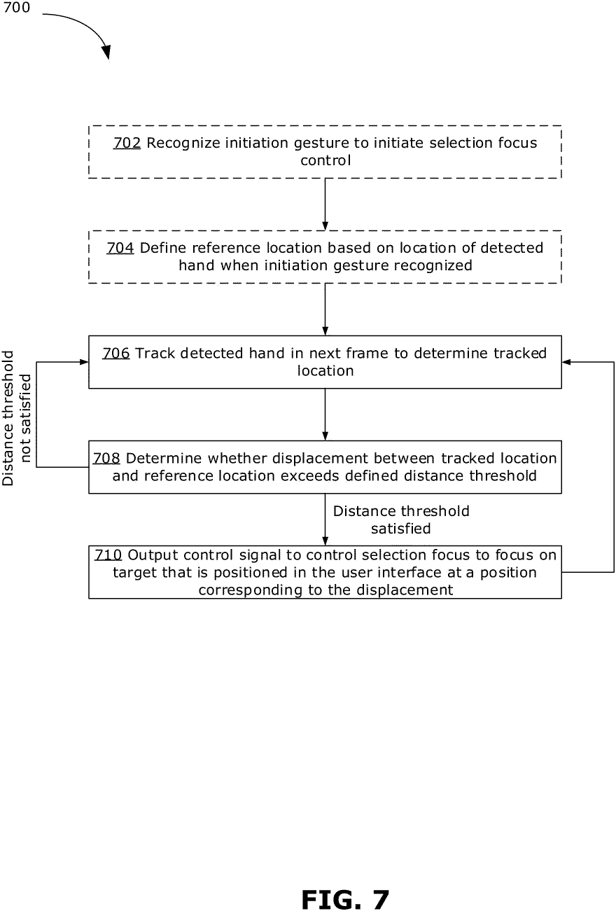

FIG. 8 is a flowchart illustrating another example method 750 for mapping the tracked location and gesture of the detected hand to a control signal. The method 750 may be referred to as “position-scroll-based” control or “hybrid” control, for example.

The method 750 may enable the selection focus to be controlled using position-based control when the selection focus is moved within the displayed area of the UI (e.g., similar to the method 700), but may additionally enable scrolling of the displayed area (e.g., in the case where the area of the UI is larger than the displayed area) when the selection focus is moved to the edge region of the displayed area.

The method 750 may include optional step 702, optional step 704, step 706 and step 708, which have been described previously. The details of these steps need not be repeated here.

If, at step 708, the displacement of between the tracked location and the reference location is determined to satisfy the defined distance threshold, the method 750 proceeds to step 752. Otherwise, the method 750 returns to step 706 to continue tracking the detected hand. The defined distance threshold may be the same as that described above with respect to FIG. 7 (e.g., one-sixth of the user’s face width).

At 752, it is determined whether the displacement between the tracked location and the reference location positions the selection focus in an edge region of the displayed area of the UI. For example, if may be determined that the selection focus is positioned in an edge region of the displayed area when the tracked location of the detected hand is at or near the border of the activation region, which may be mapped to the edge region of the displayed area. If the edge region is reached, then the method proceeds to step 754.

At 754, a control signal is outputted to cause the displayed area to be scrolled. The displayed area may be scrolled in a direction corresponding to the direction of the edge region that is reached. For example, if the selection focus is positioned in a right-side edge region, the displayed area may be scrolled (i.e., shifted) to the right.

In some examples, scrolling of the displayed area may be controlled in a step-wise fashion. For example, each time the selection focus is positioned in the edge region the displayed area may be scrolled by a discrete amount (e.g., enough to bring one row of targets into view). Each additional step of scrolling the displayed area may require the selection focus to remain in the edge region for a predefined period of time (e.g., scroll one additional step for each second the selection focus is in the edge region).

In other examples, scrolling of the displayed area may be controlled in a rate-based fashion, where the displayed area is scrolled at a speed that is dependent on how far the tracked location of the detected hand has been displaced from the reference location. For example, if the tracked location has been displaced from the reference location just enough to position the selection focus in the edge region, the displayed area may be scrolled at a first speed; and if the tracked location has been displaced much farther from the reference location (so that the selection focus would be positioned far outside of the displayed area), the displayed area may be scrolled at a second (faster) speed.

Optionally, performing step 754 may include one or both of steps 756 and 758. Steps 756 and/or 758 may be performed to help reduce or avoid the problem of “overshooting” (e.g., the displayed area being scrolled too fast and exceeding the user’s desired amount of scrolling, or the displayed area being unintentionally scrolled when the user intended to position the selection focus to focus on a target close to the edge region).

At optional step 756, the displayed area is scrolled only if the tracked speed of the detected hand is below a defined speed threshold.

At optional step 758, the displayed area is scrolled only if the selection focus remains in the edge region for at least a defined time threshold (e.g., for at least one second, or for at least 500 ms).

Steps 756 and/or 758 may help to reduce or avoid undesired scrolling of the displayed area when the user is trying to quickly move the selection focus to focus on a target close to the edge region, or if the user’s hand is jostled for example.

Regardless of how step 754 is performed, following step 754 the method 750 may return to step 706 to continue tracking the detected hand.

If the tracked location of the detected hand moves back towards the reference location while the displayed area is being scrolled, a control signal may be outputted to stop scrolling of the displayed area (not shown in FIG. 8). This may enable the user to stop scrolling of the displayed area without having to fully move the selection focus out of the edge region.

Returning to step 752, if it is determined that the selection focus is not positioned in the edge region of the displayed area, the method 750 proceeds to step 710.

At 710, as described previously with respect to FIG. 7, a control signal is outputted to control the selection focus to focus on a target that is positioned in the UI at a position corresponding to the displacement between the tracked location of the detected hand and the reference location.

The position-scroll-based control technique, as described above with reference to FIG. 8, may provide a relatively simple way for a user to control the selection focus while also enabling the user to navigate a UI that is larger than the area that can be displayed by the electronic device (e.g., in the case of an electronic device having a small display). The example described above also may include mechanisms to reduce or avoid the risk of overshooting or inadvertently scrolling.

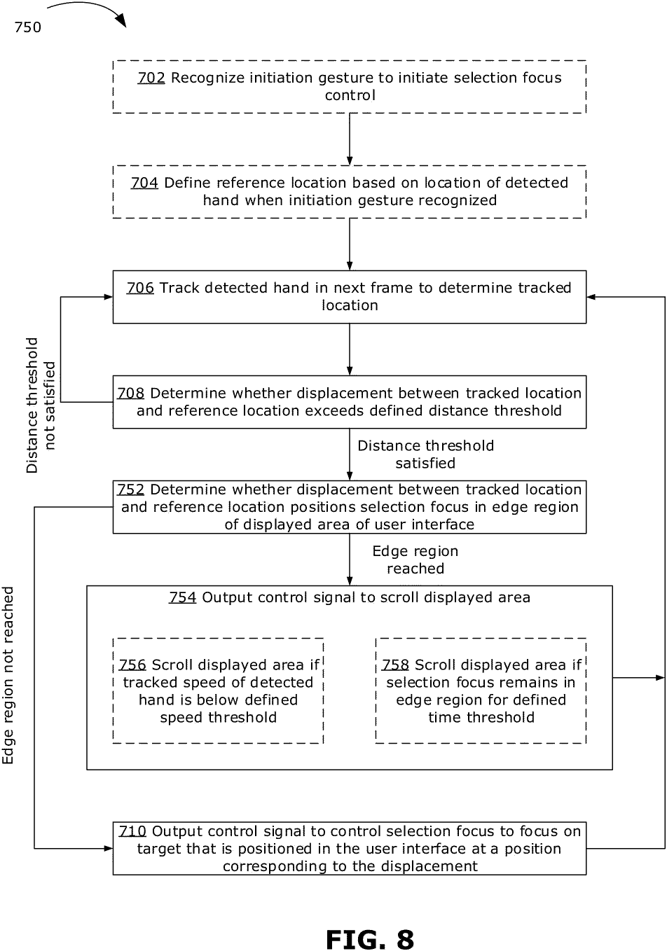

FIG. 9 is a flowchart illustrating another example method 800 for mapping the tracked location and gesture of the detected hand to a control signal. The method 800 may be referred to as “rate-based” control, for example.

The rate-based control technique may be conceptually similar to how a user would interact with a physical joystick, in that the movement of the user’s hand is used to control a direction and speed of movement of the selection focus (rather than directly controlling the position of the selection focus, such as in the method 700).

The method 800 may include optional step 702, optional step 704, step 706 and step 708, which have been described previously. The details of these steps need not be repeated here.

If, at step 708, the displacement of between the tracked location and the reference location is determined to satisfy the defined distance threshold, the method 800 proceeds to step 810. Otherwise, the method 800 returns to step 706 to continue tracking the detected hand. The defined distance threshold may be the same as that described above with respect to FIG. 7 (e.g., one-sixth of the user’s face width).

At 810, a velocity vector is computed, which is used to move the selection focus, based on the displacement between the tracked location of the detected hand and the reference location. The velocity vector may be used to move the selection focus, by multiplying the velocity vector by a timestep (e.g., depending on the responsiveness of the UI, for example the timestep may be 100 ms, or any longer or shorter time duration) and using the resulting displacement vector to determine the direction and distance that the selection focus should be moved.

The direction and magnitude of the velocity vector is a function of the direction and magnitude of the displacement between the tracked location and the reference location. For example, the direction of the velocity vector may be defined to be equal to the direction of the displacement between the tracked location and the reference location. In another example, the direction of the velocity vector may be defined as the direction along a Cartesian axis (e.g., x- or y-axis; also referred to as vertical or horizontal directions) that is closest to the direction of the displacement. For example, if the displacement of the tracked location is almost but not exactly horizontally to the right of the reference location, the velocity vector may be defined to have a direction to the right (or in the positive x-axis direction). The magnitude of the velocity vector may be computed as follows:

$$\left|v\right| = \left\{\begin{matrix}0 d < 0.15 ( F a c e W i d t h ) \\ 0.3 d d \geq 0.15 ( F a c e W i d t h )\end{matrix}\right)$$

where v denotes the velocity vector, d denotes the displacement between the tracked location and the reference location, and FaceWidth is the width of the user’s face (e.g., in the example where the user’s face is detected as the reference object). In this example, the magnitude of the velocity vector is zero when the displacement d is less than the defined distance threshold of 0.15(FaceWidth) (which is approximately equal to one-sixth of the user’s face width); and is equal to the displacement d multiplied by a multiplier (in this example a constant value 0.3) otherwise. It should be understood that the multiplier may be set to any value, including constant values larger or smaller than 0.3, or variable values. For example, the multiplier may also be a function of the width of the user’s face (e.g., the magnitude of the velocity vector may be defined as (0.3 _{*} FaceWidth)d), which may help to scale the motion of the selection focus to account for the distance between the user and the camera. Other techniques for computing the direction and magnitude of the velocity vector may be used.

If the displayed area of the UI is scrollable (e.g., the area of the UI is larger than the area that can be displayed by the electronic device), optional steps 812 and 814 may be performed to enable scrolling.

At 812, a determination may be may whether the computed velocity vector would result in the selection focus being moved to reach the edge region of the displayed area of the UI. For example, the determination may be based on whether the displacement vector would result in the selection focus being moved to the edge region of the displayed area (which may include regions outside of the displayed area).

If the edge region is reached, the method 800 proceeds to step 814; otherwise, the method proceeds to step 816.

At 814, a control signal is outputted to cause the displayed area to be scrolled. The scrolling control may be similar to that described above with respect to step 754. The displayed area may be scrolled in a direction corresponding to the direction of the edge region that is reached. For example, if the selection focus is positioned in a right-side edge region, the displayed area may be scrolled (i.e., shifted) to the right.

The scrolling may be controlled in a step-wise manner, as described above, or may be controlled to scroll at a speed based on the computed velocity vector. For example, the displayed area may be scrolled at a speed that matches the magnitude of the velocity vector.

In some examples, mechanisms similar to that described at step 756 and/or 758 may be used to avoid overshooting. For example, the displayed area may be scrolled only if the magnitude of the velocity vector is below a defined speed threshold. Additionally or alternatively, the displayed area may be scrolled only if the selection focus remains in the edge region for a time duration that satisfies a defined minimum time threshold.

Following step 814, the method 800 may return to step 706 to continue tracking the detected hand.

If scrolling of the displayed area is not enabled (e.g., the UI does not extend beyond the displayed area, or some other mechanism such as a paging button is used to move the displayed area), or if it is determined at step 812 that the edge region is not reached, the method 800 proceeds to step 816.

At 816, a control signal is outputted to control the selection focus to focus on a target in the UI based on the computed velocity vector. As described above, the velocity vector may be used to compute the displacement vector for moving the selection focus. Then, the new position of the selection focus may be computed by applying the displacement vector to the current position of the selection focus in the UI. To maintain the discrete movement of the selection focus, the UI may be divided into sub-regions that each map to a respective target within the respective sub-region. Then if the new position of the selection focus falls within a given sub-region, the selection focus is controlled to focus on the target within the given sub-region.

The method 800 may enable the selection focus to be controlled using smaller movements of the user’s hand. This may be useful in situations where the user may have limited space for movement (e.g., in a confined space), or where the user has limited ability to move their hand, for example.

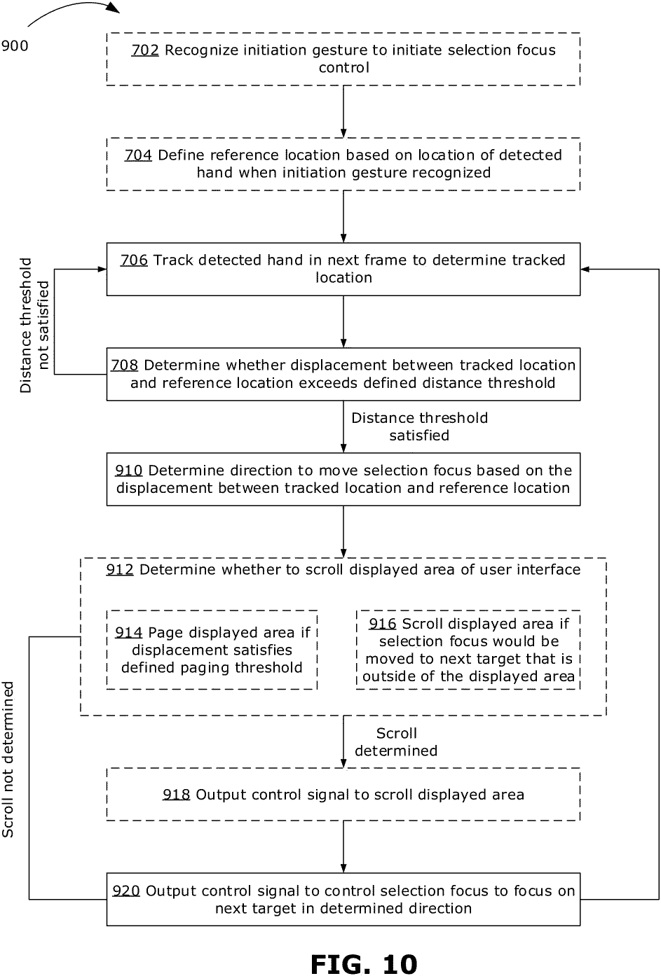

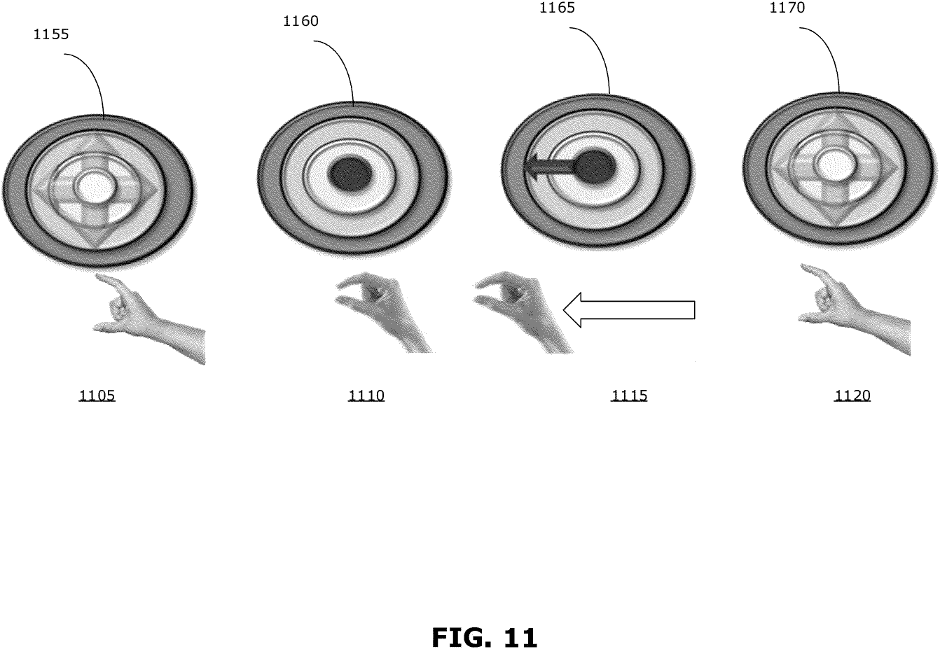

FIGS. 11 and 12 illustrate example embodiments of rate-based control, for example using the method 800.

In FIG. 11, the user first performs a pinch open gesture at 1105, which is detected and recognized within the defined activation region of the captured frame, in order to initiate the rate-based control. In this example, a virtual joystick 1155 may be displayed in the UI to provide visual feedback to the user. At 1110, the user performs a pinch closed gesture to define the reference location. The virtual joystick 1160 is updated with a dark circle in the center to indicate to the user that the reference location (i.e., the “home” or neutral position of the joystick) has been defined. At 115, the user moves their hand towards the left (indicated by white arrow) while performing the pinch closed gesture. Based on the tracked location of the hand and the displacement of the tracked location from the reference position, a velocity vector towards the left is determined (as represented by the arrow shown in the virtual joystick 1165) and the selection focus is moved towards the left. At 1120, the user performs a pinch open gesture, which may be interpreted as ending the user interaction with the virtual joystick 1170.

FIG. 12 illustrates an example of how the displacement of the user’s hand is compared with a defined distance threshold, in order to determine the velocity vector. At 1205, the user performs a pinch closed gesture to define the reference location 1260. In FIG. 12, a dotted circle is shown to represent the distance threshold 1265 relative to the reference location 1260. The distance threshold 1265 may or may not be displayed in the UI. At 1210, the tracked location of the detected hand has a displacement from the reference location 1260 that is less than the distance threshold 1265 (illustrated as being within the dotted circle). Because the displacement is less than the distance threshold 1265, this displacement does not result in any movement of the selection focus. At 1215, the tracked location of the detected hand has a displacement from the reference location 1260 that satisfies (e.g., exceeds) the distance threshold 1265 (illustrated as being outside of the dotted circle). Accordingly, the selection cursor is controlled to be moved using a velocity vector that is computed based on the direction and magnitude of the displacement, as discussed above.

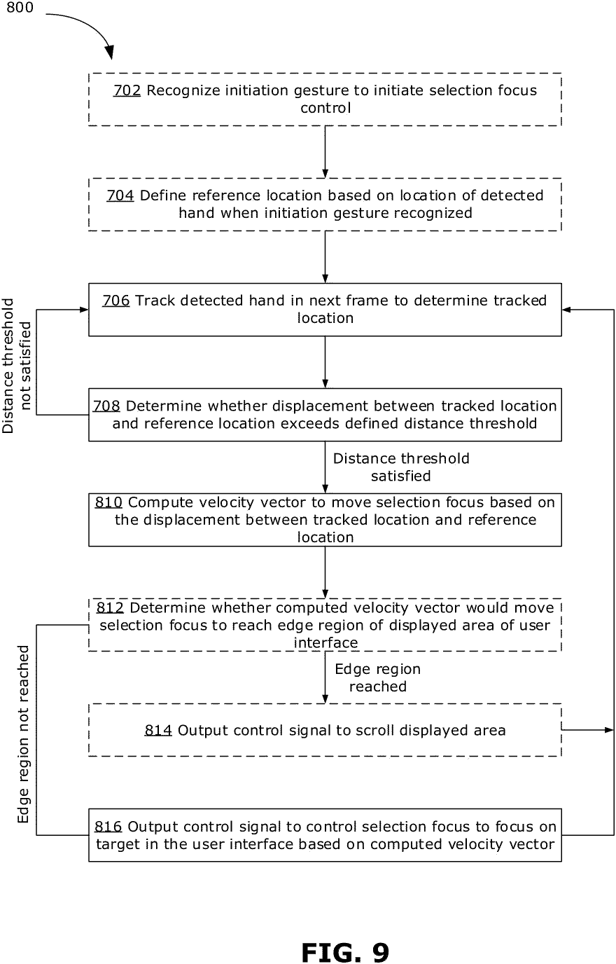

FIG. 10 is a flowchart illustrating another example method 900 for mapping the tracked location and gesture of the detected hand to a control signal. The method 900 may be referred to as “discrete” control, for example.

The discrete control technique may be conceptually similar to how a user would interact with a directional pad (or D-pad). The user performs gestures that are mapped to discrete (or “atomic”) movement of the selection focus.

The method 900 may include optional step 702, optional step 704, step 706 and step 708, which have been described previously. The details of these steps need not be repeated here.

If, at step 708, the displacement of between the tracked location and the reference location is determined to satisfy the defined distance threshold, the method 900 proceeds to step 910. Otherwise, the method 900 returns to step 706 to continue tracking the detected hand. The defined distance threshold may be the same as that described above with respect to FIG. 7 (e.g., one-sixth of the user’s face width) or may be a larger distance threshold (e.g., 0.75 times the user’s face width), for example.

At 910, the direction to move the selection focus (e.g., move in a step-wise fashion, by discretely moving one target at a time) is determined based on the displacement between the tracked location of the detected hand and the reference location. In some examples, the selection focus may be controlled to move only in along the Cartesian axes (e.g., x- and y-axes; also referred to as vertical and horizontal directions) and the direction of the displacement may be mapped to the closest Cartesian axis. For example, if the displacement of the tracked location is almost but not exactly horizontally to the right of the reference location, the direction to move the selection focus may be determined to be towards the right.

In some examples, the direction to move the selection focus may be determined only if a defined gesture (e.g., pinch open gesture followed by pinch closed gesture) is detected. Then, each time the user performs the defined gesture while the displacement is maintained may be interpreted as a control to move the selection focus one step in the determined direction. This may mimic the way a user may interact with a D-pad by repeatedly pressing a directional key to move step-by-step among the targets of the UI. In other examples, instead of using a defined gesture, some other input mechanism (e.g., verbal input or a physical button) may be used to move the selection focus one step in the determined direction. For example, the user may move their hand in a vertical direction, then use a verbal command to move the selection focus one step in the vertical direction.

If the displayed area of the UI is scrollable (e.g., the area of the UI is larger than the area that can be displayed by the electronic device), optional steps 912–916 may be performed to enable scrolling.

At 912, it is determined whether the displayed area of the UI should be scrolled. Scrolling of the displayed area may be controlled using step 914 and/or step 916, for example. The directional in which the displayed area is scrolled may correspond to the direction determined at step 910 (e.g., along one of the Cartesian axes).

Step 914 may be performed in examples where a “paging” mechanism is provided. A paging mechanism may enable the displayed area to be paged through the UI, where paging refers to the movement of the displayed area from the currently displayed area of the UI to a second adjacent, non-overlapping area (also referred to as a “page”) of the UI (e.g., similar to using the page up or page down button on a keyboard). At 914, if the displacement between the tracked location and the reference location satisfies (e.g., meets or exceeds) a defined paging threshold (which is larger than the distance threshold), the displayed area may be scrolled to the next page in the UI. For example, paging may be performed if the displacement is greater than 1.25 times the user’s face width.

Alternatively or additionally, using step 916, the displayed area may be scrolled if the determined direction would result in the selection focus being moved to a next target that is outside of the current displayed area. For example, if the selection focus is already focused on a rightmost target in the current displayed area, and the determined direction is towards the right, then the displayed area may be scrolled towards the right by one step (e.g., move by one column of targets to the right) so that the next target to the right (which was previously outside of the displayed area) is displayed (and focused on at step 920).

If, using step 914 and/or 916, scrolling of the displayed area is determined, the method 900 proceeds to step 918.

At 918, a control signal is outputted to scroll the displayed area. The control signal may cause the displayed area to be scrolled in a page-wise manner (e.g., if step 914 is performed) or in a step-wise manner (e.g., if step 916 is performed), for example. Following step 918, the method 900 may proceed to step 920 to automatically move the selection focus to the next target in the determined direction after the scrolling. For example, if the displayed area is scrolled to the right, then the next target to the right (which was previously not in the displayed area but is now within view) may be automatically focused on by the selection focus. Alternatively, following step 918, the method 900 may return to step 706 to continue tracking the detected hand.

If scrolling of the displayed area is not enabled (e.g., the UI does not extend beyond the displayed area), or if it is determined at step 912 that the displayed area should not be scrolled, the method 900 proceeds to step 920.

At 920, a control signal is outputted to control the selection focus to focus on the next target in the UI in the determined direction. For example, if the direction determined at step 910 is towards the left then the selection focus is moved to focus on the next target towards the left.

The method 900 may enable the selection focus to be controlled using relatively small movements of the user’s hand. Because the method 900 controls the selection focus in discrete defined steps (e.g., moving one target at a time), the user may be able to use the discrete control technique to control the selection focus while keeping their eyes mostly focused on a different task. Further, the method 900 may enable a user with poor motor control to more accurately control the selection focus, because the movement of the selection focus is less dependent on the amount of displacement of the user’s hand.

Different techniques for mapping the location and gesture of a detected hand to control a selection focus of a user interface have been described above. Different control techniques may be more advantageous in different situations, as discussed above.

It should be understood that the selection focus controller 300 may support any one or more (or all) of the control techniques described above. In some examples, the selection focus controller 300 may switch between different control techniques (e.g., based on user preference, or based on the specific situation). For example, if the selection focus controller 300 is used to control the UI of an in-vehicle system, a control technique that requires less visual feedback (e.g., discrete control, as described with reference to FIG. 10) may be used when the vehicle is moving and another control technique that is faster but requires more visual feedback (e.g., rate-based control, as described with reference to FIG. 9) may be used when the vehicle is stationary or is operating in autonomous mode.

In some examples, some visual feedback may be provided to the user, in addition to display of the UI, to help the user to more accurately and precisely perform gesture inputs. Different forms of visual feedback may be provided. Some examples are described below, which are not intended to be limiting.

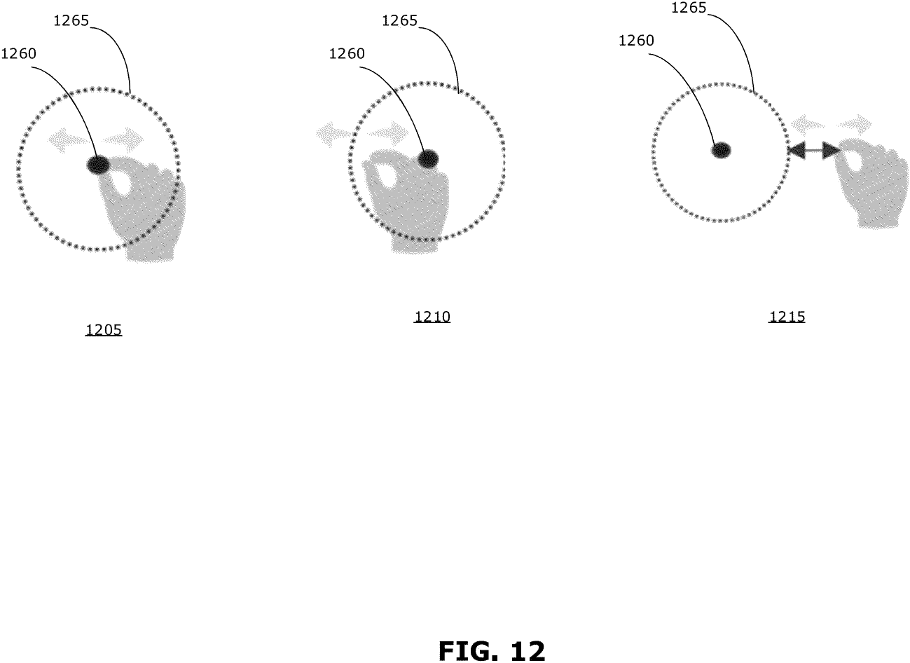

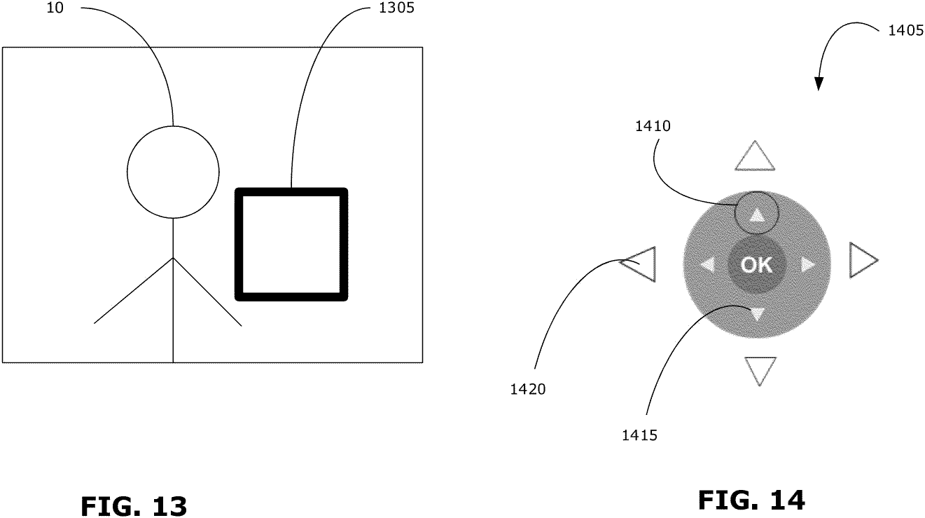

FIGS. 13 and 14 illustrate some examples of visual feedback that may be displayed to a user to help guide the user’s gesture inputs.

FIG. 13 illustrates an example AR display in which a real-life captured video is overlaid with a virtual indicator of the activation region. In this example, the face of the user 10 may be detected within a frame of video data and may be detected as the defined reference object. The activation region may be defined (e.g., the size and position of the activation region may be defined) relative to the reference object (i.e., the face), as described above. In this example, the AR display includes a virtual indicator 1305 (e.g., an outline of the activation region) that allows the user 10 to be aware of the position and size of the defined activation region. This may enable the user 10 to more easily position their hand in within the activation region. In some examples, such an AR display may be provided in addition to display of the UI (e.g., the AR display may be provided as an inset in a corner of the UI), to provide visual feedback that may help the user to use gestures to interact with the UI.

FIG. 14 illustrates an example virtual D-pad 1405 that may be displayed when the discrete control technique is used to control the selection focus. For example, the virtual D-pad 1405 may be displayed in a corner of the UI. The reference location (e.g., defined as the location of the detected hand when the user performs an initiation gesture) maps to the center of the virtual D-pad 1405. Then, displacement of the tracked location of the detected hand may be mapped to a determined direction on the virtual D-pad 1405, which may be represented using an indicator 1410 (e.g., a circle, a dot, etc.). In this example, the indicator 1410 is shown over one of the four directional arrows 1415 of the virtual D-pad 1405, indicating that the determined direction is upwards. In this example, the virtual D-pad 1405 also includes paging arrows 1420 indicating that the displayed area can be scrolled in a page-wise manner. If the displacement of the tracked location is greater than the defined paging threshold, the indicator 1410 may be shown over one of the paging arrows 1420, indicating that the displayed area can be paged.

In various examples, the present disclosure has described methods and apparatuses that enable a user to interact with a UI by controlling a selection focus. The selection focus may be used to focus on different targets in the UI in a discrete manner. In particular, the present disclosure describes examples that enable mid-air hand gestures to be used to control a selection focus in a UI.

Examples of the present disclosure enable an activation region (in which gesture inputs may be detected and recognized) to be defined relative to a reference object. For example, the activation region may be sized and positioned based on detection of a user’s face. This may help to ensure that the activation region is placed in a way that is easy for the user to perform gestures.

The present disclosure has described some example control techniques that may be used to map gesture inputs to control of the selection focus, including a position-based control technique, a position-scroll-based control technique, a rate-based control technique and a discrete control technique. Examples for controlling scrolling of the displayed area of the UI have also been described, including mechanisms that may help to reduce or avoid overshooting errors.

Examples of the present disclosure may be useful for a user to remotely interact with a UI in situations where the user’s eyes are focused on a different task. Further, examples of the present disclosure may be useful for a user to remotely interact with a UI in situations where complex and/or precise gesture inputs may be difficult for the user to perform.

Examples of the present disclosure may be applicable in various contexts, including interactions with in-vehicle systems, interactions with public kiosks, interactions with smart appliances, interactions in AR and interactions in VR, among other possibilities.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable an electronic device to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
detecting a hand within a defined activation region in a first frame of video data, a reference location being determined within the defined activation region;
tracking the detected hand to determine a tracked location of the detected hand in at least a second frame of video data; and
outputting a control signal to control a selection focus to focus on a target in a user interface, movement of the selection focus being controlled based on a displacement between the tracked location and the reference location.

2. The method of claim 1, further comprising:
determining whether the displacement between the tracked location and the reference location satisfies a defined distance threshold;
wherein the control signal is outputted in response to determining that the defined distance threshold is satisfied.

3. The method of claim 1, further comprising:
recognizing a gesture of the detected hand in the first frame as an initiation gesture; and
defining a first location of the detected hand in the first frame as the reference location.

4. The method of claim 1, further comprising:
detecting, in the first frame or a third frame of video data that is prior to the first frame, a reference object; and
defining a size and position of the activation region relative to the detected reference object.

5. The method of claim 4, wherein the detected reference object is one of:
a face;
a steering wheel;
a piece of furniture;
an armrest;
a podium;
a window;
a door; or
a defined location on a surface.

6. The method of claim 1, further comprising:
recognizing, in the second or a fourth frame of video data that is subsequent to the second frame, a gesture of the detected hand as a confirmation gesture; and
outputting a control signal to confirm selection of the target that the selection focus is focused on in the user interface.

7. The method of claim 1, wherein outputting the control signal comprises:
mapping the displacement between the tracked location and the reference location to a mapped position in the user interface; and
outputting the control signal to control the selection focus to focus on the target that is positioned in the user interface at the mapped position.

8. The method of claim 7, further comprising:
determining that the mapped position is an edge region of a displayed area of the user interface; and
outputting a control signal to scroll the displayed area.

9. The method of claim 8, wherein the control signal to scroll the displayed area is outputted in response to determining at least one of: a tracked speed of the detected hand is below a defined speed threshold; or the mapped position of the selection focus remains in the edge region for at least a defined time threshold.

10. The method of claim 8, further comprising:
determining a speed to scroll the displayed area, based on the displacement between the tracked location and the reference location;
wherein the control signal is outputted to scroll the displayed area at the determined speed.

11. The method of claim 1, wherein outputting the control signal comprises:
computing a velocity vector for moving the selection focus, the velocity vector being computed based on the displacement between the tracked location and the reference location; and
outputting the control signal to control the selection focus to focus on the target in the user interface based on the computed velocity vector.

12. The method of claim 11, further comprising:
determining that the computed velocity vector would move the selection focus to an edge region of a displayed area of the user interface; and
outputting a control signal to scroll the displayed area.

13. The method of claim 12, wherein the control signal to scroll the displayed area is outputted in response to determining at least one of: a magnitude of the velocity is below a defined speed threshold; or the selection focus remains in the edge region for at least a defined time threshold.

14. The method of claim 12, further comprising:
determining a speed to scroll the displayed area, based on the computed velocity vector;
wherein the control signal is outputted to scroll the displayed area at the determined speed.

15. The method of claim 1, wherein outputting the control signal comprises:
determining a direction to move the selection focus based on a direction of the displacement between the tracked location and the reference location; and
outputting the control signal to control the selection focus to focus on a next target in the user interface in the determined direction.

16. The method of claim 15, wherein determining the direction to move the selection focus is in response to recognizing a defined gesture of the detected hand in the first frame.

17. The method of claim 15, further comprising:
determining that the displacement between the tracked location and the reference location satisfies a defined paging threshold that is larger than the defined distance threshold; and
outputting a control signal to scroll a displayed area of the user interface in the determined direction.

18. The method of claim 15, further comprising:
determining that the next target in the user interface is outside of a displayed area of the user interface; and
outputting a control signal to scroll the displayed area in the determined direction, such that the next target is in view.

19. An apparatus comprising:
a processing unit coupled to a memory storing machine-executable instructions thereon, wherein the instructions, when executed by the processing unit, cause the apparatus to:
detect a hand within a defined activation region in a first frame of video data, a reference location being determined within the defined activation region;
track the detected hand to determine a tracked location of the detected hand in at least a second frame of video data; and
output a control signal to control a selection focus to focus on a target in a user interface, movement of the selection focus being controlled based on a displacement between the tracked location and the reference location.

20. The apparatus of claim 19, wherein the apparatus is one of:
a smart appliance;
a smartphone;
a tablet;
an in-vehicle system;
an internet of things device;
an electronic kiosk;
an augmented reality device; or
a virtual reality device.
